(19) United States
(12) Patent Application Publication
(10) Pub. No.: US 2026/0230494 A1
(43) Pub. Date: Aug. 6, 2026

(54) NETWORK SECURITY BASED ON CRITICAL NODE GAME (CNG)

(71) Applicant: Telefonaktiebolaget LM Ericsson (publ), Stockholm (SE)

(72) Inventors: Amine BOUKHTOUTA, Laval (CA); Gabriele DRAGOTTO, Princeton, NJ (US); Andrea LODI, New York, NY (US); Mehdi TAOBANE, Montreal (CA)

(21) Appl. No.: 19/148,441

(22) PCT Filed: Feb. 2, 2024
(86) PCT No.: PCT/IB2024/050985

§ 371 Date: Jul. 16, 2025

Related U.S. Application Data
(60) Provisional application No. 63/482,879, filed on Feb. 2, 2023.

(51) Int. Cl. H04L 9/40; H04L 41/12; H04L 41/14

(52) U.S. Cl. CPC H04L 63/1433; H04L 41/12; H04L 41/145

(57) ABSTRACT

A method, system and apparatus are disclosed. In some embodiments, a security node is provided. The security node is configured to: use a topology of a plurality of network nodes and associated network data to simulate a simultaneous and non-cooperative attacker-defender model to assess a security risk, where an attacker solves a combinational operation problem based on variables associated with a defender, and the defender solves a combination operational problem based on variables associated with the attacker, determine a NE profile that includes: a first estimate of a security risk from a perspective of the defender that maximizes a defender's payoff based on the model, and a second estimate of a security risk from a perspective of the attacker that maximizes an attacker's payoff based on the model, and provide a recommendation for adapting a level of security based on the NE profile.

### FIELD

The present disclosure relates to network security, and in particular, to network security through critical node game (CNG).

### BACKGROUND

Some existing studies provide game-theoretic models for cyber-security. One study asserts that game-theoretical frameworks for network security primarily possess two strengths. First, the game-theoretical frameworks can model complex strategic decision-making settings and compare several scenarios before making a decision. Second, compared to some of the state-of-the-art heuristic approaches, game theory models are quantitative and exact methods. For example, several studies have modeled a similar attacker-defender game to derive insights into the defender's strategy and the resources needed to defend.

Some interdiction games studies assume that players act in rounds, however this assumption may reduce the robustness of the optimization.

### Critical Node Problem (CNP) Game Theoretic Modeling

Another study relates to the problem of removing the most vital arcs in a network to maximize the shortest path among pairs of nodes. Similarly, another study relates to the problem of finding the most vital node in a network to maximize the weight of an independent set. Another study applied a similar analysis to model an interdiction problem to control the spread of infectious diseases in hospitals. Similar ideas have been described in the context of epidemics and computer networks. Another study proposed an optimization problem to determine the optimal location of network jamming devices to maximize the network disruption. Another study studied the firefighter problem, i.e., the problem of deciding which node to defend in a graph considering a temporal dynamic that spreads a virus or a fire over the nodes.

Several studies investigated the problem of determining the critical node in a combinatorial optimization contexts, such as matching graphs, network flows graphs, and in general, in graphs with special structures.

### CNP Mathematical Formulation

Let G=(V,E) be an undirected graph representing the cloud network topology, where the resources V (e.g., routers, servers, cloud instances) are linked through some connections E. Each edge e∈E is made of a pair of nodes i,j∈V so that (i,j) is a connection between the two resources i and j. Definition 1 is an abstract definition of the CNP.
Definition 1 (Critical Node Problem). Given a graph G=(V,E) and k∈N, the CNP is the problem of removing a subset of nodes S⊆V with |S|<k so that G=(V\S, E) minimizes a function of the connectivity of G.

In other words, the CNP asks to detect the most critical k nodes of G with respect to a given connectivity function on G. This function can be, for instance, the number of pairwise connected nodes or the number of connected components in G. Similarly, when G represents a cloud network, the problem equivalently asks to determine the k most critical devices in the network so that removing S maximizes the service disruption (i.e., the number of unavailable resources) on G. The CNP possesses an intuitive formulation as a combinatorial optimization problem and often as an equivalent integer program.

However, the usage of observability tools on cloud premises including distributed and cloud native tools are under-used since they are deployed to detect potential threats.

### SUMMARY

Some embodiments advantageously provide methods, systems, and apparatuses for network security through critical node game (CNG).

While observability tools are used to detect potential threats, observability tools are not used to collect insights that may allow security experts to provide insights of underlying cyber-security risk knowing the interaction between different components connected in cloud environment including IT telco managed services (e.g., 5G networks).

Cloud networks are the backbone of the modern distributed internet infrastructure as they provision the on-demand resources organizations and individuals use daily. However, any abrupt cyber-attack could disrupt the provisioning of some of the cloud resources fulfilling the needs of customers, industries, and governments. One or more embodiments described herein provide a game-theoretic model that assesses the cyber-security risk of cloud networks and informs security experts on the optimal security strategies. These one or more embodiments may combine game theory and combinatorial optimization to assess the unexpected network disruptions caused by potential malicious cyber-attacks under uncertainty.

In one or more embodiments, a model is provided to assess the risk associated with cyber security in virtualized ecosystem by considering a certain a priori knowledge collected from observability artifacts. In one or more embodiments, the game-theoretic framework assesses cloud networks' security posture (i.e., readiness to handle attacks) and provides network operators with an a priori security recommendations.

According to one aspect of the present disclosure, a method implemented in a security node is provided. A topology of a plurality of network nodes and associated network data in a network is used to simulate a simultaneous and non-cooperative attacker-defender model to assess a security risk associated with each of the plurality of network nodes, where: an attacker solves a combinational operation problem based on variables associated with a defender, and the defender solves a combination operational problem based on variables associated with the attacker. A Nash Equilibrium, NE, profile is determined where the NE profile that includes: a first estimate of a security risk associated with each of the plurality of network nodes from a perspective of the defender that maximizes a defender's payoff based on the simultaneous and non-cooperative attacker-defender model, and a second estimate of a security risk associated with each of the plurality of network nodes from a perspective of the attacker that maximizes an attacker's payoff based on the simultaneous and non-cooperative attacker-defender model. A recommendation for at least one critical network node of the plurality of network nodes for adapting a level of security associated with the topology based on the NE profile is provided.

According to one or more embodiments of this aspect, in a combination operation problem solved by the attacker, the attacker is configured to maximum network disruption on the network; and in the combination operation problem solved by the defender, the defender is configured to maximize network connectivity of the network.

According to one or more embodiments of this aspect, a result of the NE profile corresponds to a price of security, POS, value, and a POS value greater than 1 indicating that there exists a loss in the defender's payoff caused by a plurality of NE conditions associated with the NE profile.

According to one or more embodiments of this aspect, a result of the NE profile corresponds to a price of aggression, POA, value; and a POA value greater than 1 indicating that there exists a loss in the attacker's payoff caused by a plurality of NE conditions associated with the NE profile.

According to one or more embodiments of this aspect, the attacker's payoff and the defender's payoff corresponds to an outcome of the simultaneous and non-cooperative attacker-defender model that is based on strategies of the attacker and defender.

According to one or more embodiments of this aspect, the NE is an approximation computed after a predefined time limit.

According to one or more embodiments of this aspect, the adapting of the level of security associated with the topology comprises at least one of: provisioning additional security assets and adjusting a security strategy.

According to one or more embodiments of this aspect, the adapting of the level of security associated with the topology is configured to reduce the attacker's payoff.

According to one or more embodiments of this aspect, an attack is detected on at least one of the plurality of network nodes, and the simulation is in response to the detected attack.

According to one or more embodiments of this aspect, the network data comprises at least one of: traffic exchange among the plurality of network nodes, and information received from monitoring the topology.

According to another aspect of the present disclosure, a security node is provided. The security node comprises processing circuitry configured to: using a topology of a plurality of network nodes and associated network data in a network to simulate a simultaneous and non-cooperative attacker-defender model to assess a security risk associated with each of the plurality of network nodes, where: an attacker solves a combinational operation problem based on variables associated with a defender; and the defender solves a combination operational problem based on variables associated with the attacker. The processing circuitry is further configured to determine a Nash Equilibrium, NE, profile that includes: a first estimate of a security risk associated with each of the plurality of network nodes from a perspective of the defender that maximizes a defender's payoff based on the simultaneous and non-cooperative attacker-defender model; and a second estimate of a security risk associated with each of the plurality of network nodes from a perspective of the attacker that maximizes an attacker's payoff based on the simultaneous and non-cooperative attacker-defender model. The processing circuitry is further configured to provide a recommendation for at least one critical network node of the plurality of network nodes for adapting a level of security associated with the topology based on the NE profile.

According to one or more embodiments of this aspect, in a combination operation problem solved by the attacker, the attacker is configured to maximum network disruption on the network, and in the combination operation problem solved by the defender, the defender is configured to maximize network connectivity of the network.

According to one or more embodiments of this aspect, a result of the NE profile corresponds to a price of security, POS, value; and a POS value greater than 1 indicating that there exists a loss in the defender's payoff caused by a plurality of NE conditions associated with the NE profile.

According to one or more embodiments of this aspect, a result of the NE profile corresponds to a price of aggression, POA, value; and a POA value greater than 1 indicating that there exists a loss in the attacker's payoff caused by a plurality of NE conditions associated with the NE profile.

According to one or more embodiments of this aspect, the attacker's payoff and the defender's payoff correspond to an outcome of the simultaneous and non-cooperative attacker-defender model that is based on strategies of the attacker and defender.

According to one or more embodiments of this aspect, the NE is an approximation computed after a predefined time limit.

According to one or more embodiments of this aspect, the adapting of the level of security associated with the topology comprises at least one of: provisioning additional security assets, and adjusting a security strategy.

According to one or more embodiments of this aspect, the adapting of the level of security associated with the topology is configured to reduce the attacker's payoff.

According to one or more embodiments of this aspect, the processing circuitry is further configured to detect an attack on at least one of the plurality of network nodes, and the simulation being in response to the detected attack.

According to one or more embodiments of this aspect, the network data comprises at least one of: traffic exchange among the plurality of network nodes, and information received from monitoring the topology.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is another example schematic diagram of an exemplary network architecture according to the principles in the present disclosure;

FIG. 4 is a flowchart illustrating exemplary methods implemented in a communication system including a host computer, a network node and a wireless device for executing a client application at a wireless device according to some embodiments of the present disclosure;

FIG. 5 is a flowchart illustrating exemplary methods implemented in a communication system including a host computer, a network node and a wireless device for receiving user data at a wireless device according to some embodiments of the present disclosure;

FIG. 6 is a flowchart illustrating exemplary methods implemented in a communication system including a host computer, a network node and a wireless device for receiving user data from the wireless device at a host computer according to some embodiments of the present disclosure;

FIG. 7 is a flowchart illustrating exemplary methods implemented in a communication system including a host computer, a network node and a wireless device for receiving user data at a host computer according to some embodiments of the present disclosure;

FIG. 8 is a flowchart of an exemplary process in a security node according to some embodiments of the present disclosure;

FIG. 9 is a flowchart of another exemplary process in a security node according to some embodiments of the present disclosure;

FIG. 10 is a diagram of an algorithm according to some embodiments of the present disclosure;

FIG. 11 is a diagram of an example CNG model simulation according to some embodiments of the present disclosure;

FIG. 12 is an example of network according to some embodiments of the present disclosure;

FIG. 13 is an example of a cloud implementation according to some embodiments of the present disclosure; and

FIG. 14 is an example modeling node in an ORAN architecture according to some embodiments of the present disclosure.

### DETAILED DESCRIPTION

As discussed above, several studies have modeled an attacker-defender game (e.g., model of an interactive situation among players, any set of circumstances that has a result dependent on the actions of two or more decision-makers (players), “game” within the context of game theory principles, etc.) to derive insights into the defender's strategy and the resources needed to defend. However, in contrast with this approach (i.) one or more embodiments formulate a problem starting from a graph, thus incorporating the structure of the network inside the model, and (ii.) each player's problem is represented as an optimization problem, (iii.) one or more embodiments compute and select a specific Nash Equilibrium (NE).

Further, some interdiction games studies assume that players act in rounds, whereas one or more embodiments described herein approaches the game theoretic problem by letting the attacker and defender play simultaneously without knowing the opponents' strategy. In this sense, this approach is closer to the realm of robust optimization than to the one of interdiction games. Further, in contrast to the present disclosure, the previous works assume a sequential structure where the network designer plays first, and the attacker follows, whereas one or more embodiments described herein assume players act simultaneously. In one or more embodiments, the attacker and defender playing simultaneously may refer to a situation where players choose their strategy (i.e., solve their optimization problems) simultaneously without knowing the other players' strategies.

Several other studies investigated the problem of determining the critical node in a combinatorial optimization contexts, such as matching graphs, network flows graphs, and in general, in graphs with special structures. One or more embodiments described herein complements the one or more of these studies by extending the CNP to a multi-agent non-cooperative setting, as opposed to a single-agent model, and by contextualizing the model in cloud networks cyber-security.

Before describing in detail exemplary embodiments, it is noted that the embodiments reside primarily in combinations of apparatus components and processing steps related to network security through critical node game (CNG). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide network security through critical node game (CNG).

One or more embodiments described herein focus on a CNP formulated as a knapsack problem. Let xᵢ be a variable associated with each node i∈V, and let xᵢ−1 if and only if i is deleted from G. The subset S is then the set xᵢ:xᵢ−1. If a function ƒ(x) measures the connectivity of G\S induced by x, the CNP corresponds to the problem

$${max}_{x} f ( x ) : {w}^{T} x \leq W , x ∈ 0 , {1}^{\vert V \vert} , \qquad ( 1 )$$

where w∈

$${ℝ}_{+}^{\vert V \vert}$$

and W∈ [symbol] are the parameters of the weighted knapsack constraint. Whenever w is a vector of ones, the constraint becomes a knapsack constraint asking to remove at most └W┘ nodes from G.

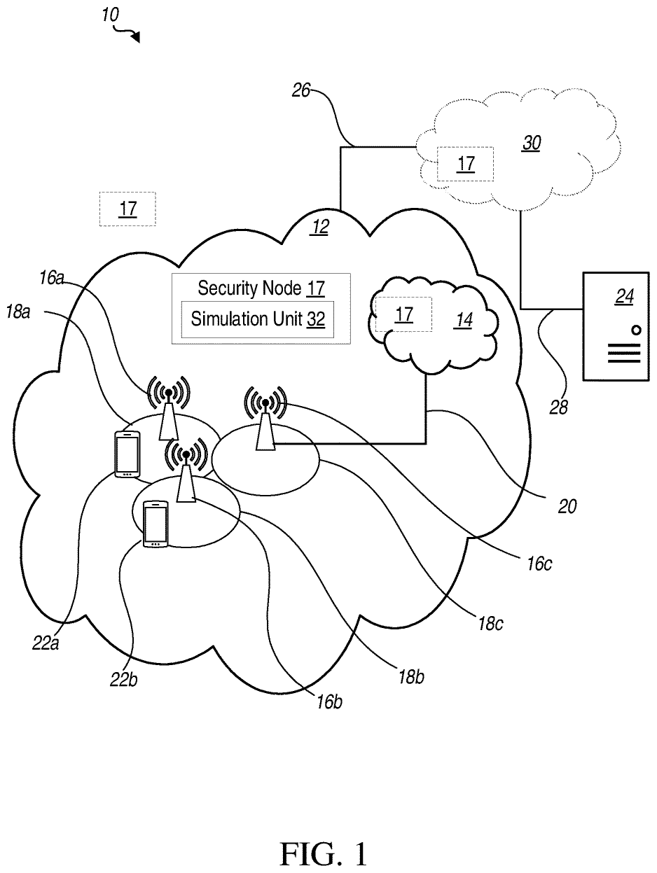

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Further, system 10 includes one or more security nodes 17 as described herein. Security node 17 may be part of one or more networks described herein.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A security node 17 is configured to include a simulation unit 32 which is configured to perform one or more security node 17 functions as described herein such as with respect to network security through critical node game (CNG).

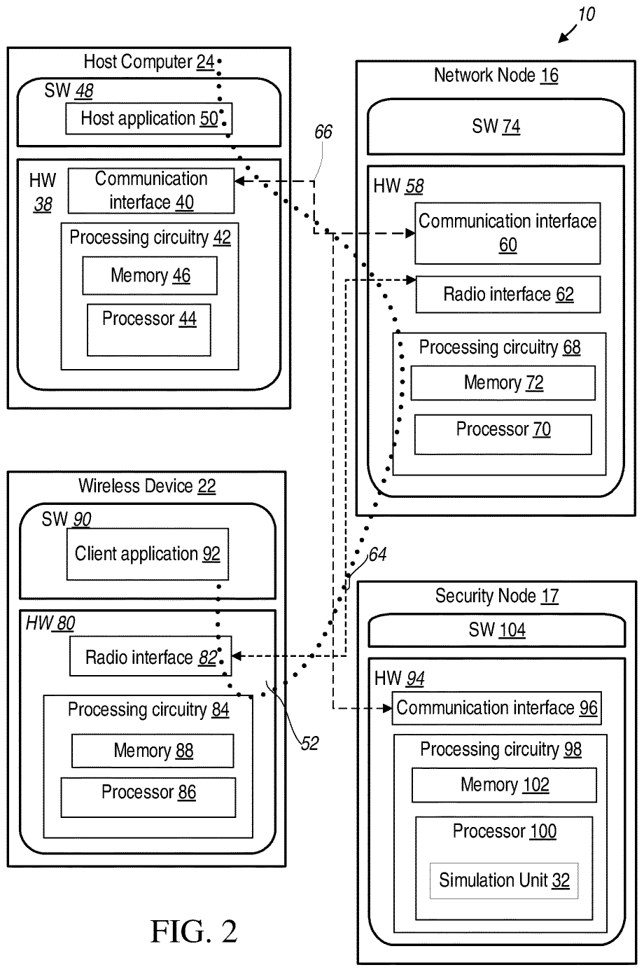

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

The communication system 10 further includes a security node 17 provided in a communication system 10 and including hardware 94 enabling it to communicate with one or more entities in communication system 10. The hardware 94 may include a communication interface 96 for setting up and maintaining a wired or wireless connection with an interface of a different communication device of the communication system 10. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 94 of the security node 17 further includes processing circuitry 98. The processing circuitry 98 may include a processor 100 and a memory 102. In particular, in addition to or instead of a processor, such as a central processing unit, and memory, the processing circuitry 98 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 100 may be configured to access (e.g., write to and/or read from) the memory 102, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the security node 17 further has software 104 stored internally in, for example, memory 102, or stored in external memory (e.g., database, storage array, network storage device, etc.) accessible by the security node 17 via an external connection. The software 104 may be executable by the processing circuitry 98. The processing circuitry 98 may be configured to control any of the methods and/or processes described herein and/or to cause such methods, and/or processes to be performed, e.g., by security node 17. Processor 100 corresponds to one or more processors 100 for performing security node 17 functions described herein. The memory 102 is configured to store data, programmatic software code and/or other information described herein. In some embodiments, the software 104 may include instructions that, when executed by the processor 100 and/or processing circuitry 98, causes the processor 100 and/or processing circuitry 98 to perform the processes described herein with respect to security node 17. For example, processing circuitry 98 of the security node 17 may include simulation unit 32 configured to perform one or more security node 17 functions as described herein such as with respect to network security through critical node game (CNG).

In some embodiments, the inner workings of the network node 16, WD 22, security node 17, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show “unit” such as simulation unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

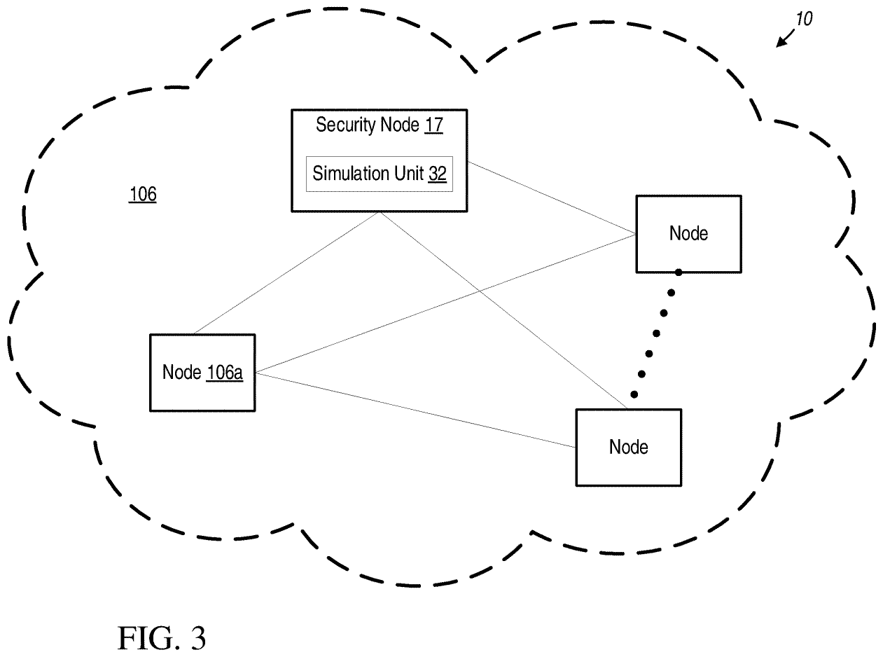

FIG. 3 is another example schematic diagram of a communication system 10, according to some embodiments of the present disclosure. In particular, security node 17 is in communication with cloud network 106 that includes one or more nodes 108a-108n (collectively referred to as node 108). Node 108 may be a cloud server/node, or other network entity associated with a finite amount of resources (e.g., computation resources, processor resources, etc.). As described below, security node 17 may be configured to simulate a simultaneous and non-cooperative attacker-defender game at least, in part, to adjust at least one security strategy for a network 106.

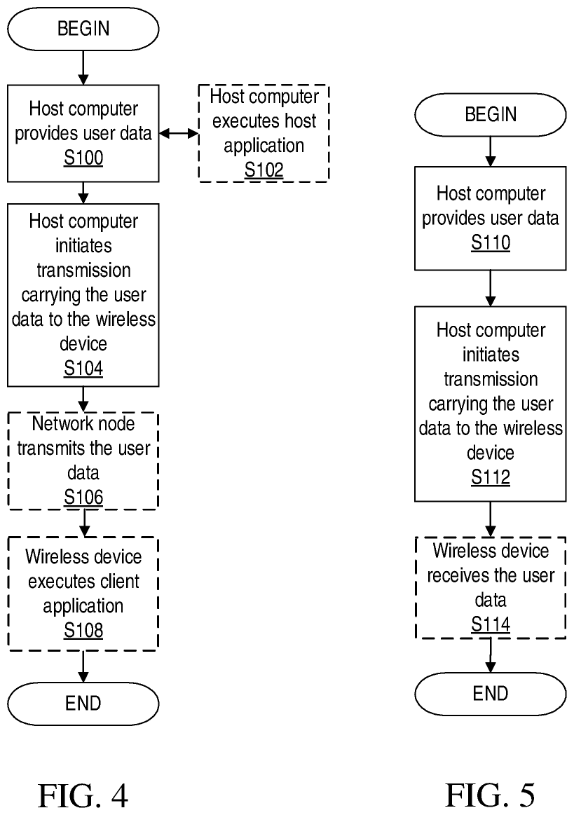

FIG. 4 is a flowchart illustrating an exemplary method implemented in a communication system, such as, for example, the communication system of FIGS. 1 and 2, in accordance with one embodiment. The communication system may include a host computer 24, a network node 16, security node 17 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an exemplary method implemented in a communication system, such as, for example, the communication system of FIG. 1, in accordance with one embodiment. The communication system may include a host computer 24, a network node 16, security node 17 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

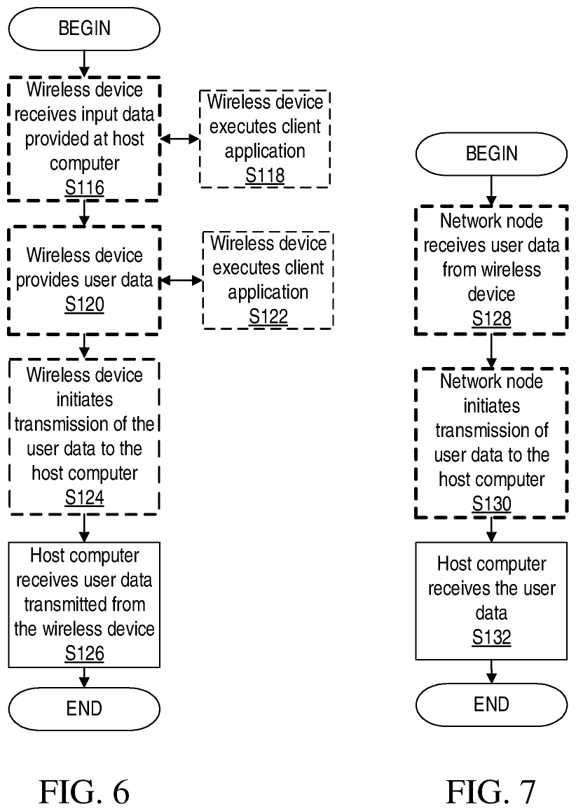

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

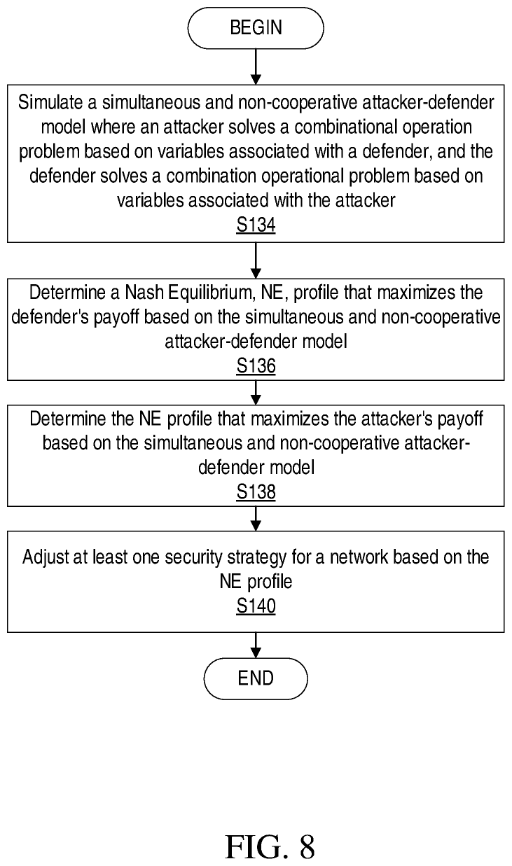

FIG. 8 is a flowchart of an exemplary process in a security node 17 according to one or more embodiments of the present disclosure. One or more blocks described herein may be performed by one or more elements of security node 17 such as by one or more of processing circuitry 98 (including the simulation unit 32), processor 100, and/or communication interface 96. Security node 17 is configured to simulate (Block S134) a simultaneous and non-cooperative attacker-defender model where: an attacker solves a combinational operation problem based on variables associated with a defender and the defender solves a combination operational problem based on variables associated with the attacker, as described herein. Security node 17 is configured to determine (Block S136) a Nash Equilibrium, NE, profile that maximizes the defender's payoff based on the simultaneous and non-cooperative attacker-defender model, as described herein. Security node 17 is configured to determine (Block S138) the NE profile that maximizes the attacker's payoff based on the simultaneous and non-cooperative attacker-defender model, as described herein. Security node 17 is configured to adjust (Block S140) at least one security strategy for a network based on the NE profile, as described herein.

According to one or more embodiments, in the combination operation problem solved by the attacker where the attacker is configured to maximum network disruption on the network, and where, in the combination operation problem solved by the defender, the defender is configured to maximize network connectivity of the network.

According to one or more embodiments, a result of the NE profile corresponds to a price of security, POS, value, and a POS value greater than 1 indicating that there exists a loss in the defender's payoff caused by NE conditions.

According to one or more embodiments, a result of the NE profile corresponds to a price of aggression, POA, value, and a POA value greater than 1 indicating that there exists a loss in the attacker's payoff caused by NE conditions.

According to one or more embodiments, the attacker's payoff and the defender's payoff corresponds to an outcome of the simultaneous and non-cooperative attacker-defender model that is based on strategies of the attacker and defender.

According to one or more embodiments, the NE is an approximation computed after a predefined time limit.

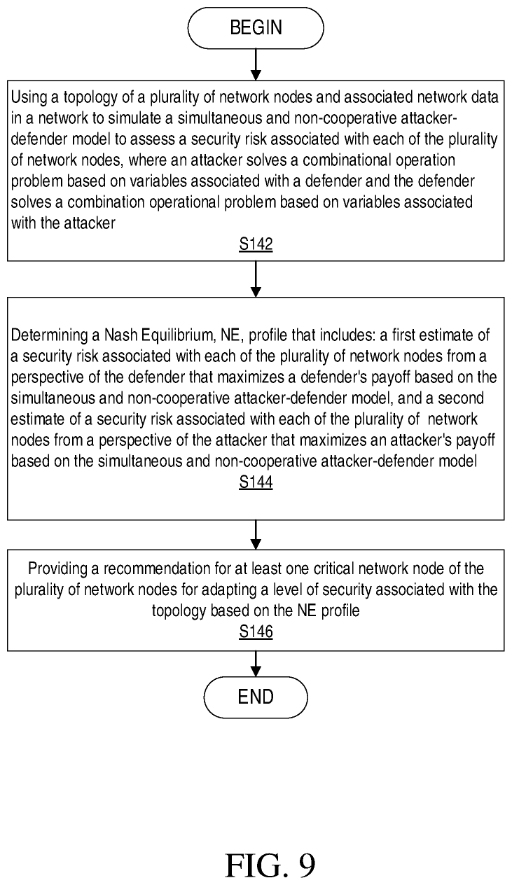

FIG. 9 is a flowchart of an exemplary process in a security node 17 according to one or more embodiments of the present disclosure. One or more blocks described herein may be performed by one or more elements of security node 17 such as by one or more of processing circuitry 98 (including the simulation unit 32), processor 100, and/or communication interface 96. Security node 17 is configured to use (Block S142) a topology of a plurality of network nodes 16 and associated network data in a network to simulate a simultaneous and non-cooperative attacker-defender model to assess a security risk associated with each of the plurality of network nodes 16, where: an attacker solves a combinational operation problem based on variables associated with a defender, and the defender solves a combination operational problem based on variables associated with the attacker, as described herein. Security node 17 is configured to determine (Block S144) a Nash Equilibrium, NE, profile that includes: a first estimate of a security risk associated with each of the plurality of network nodes 16 from a perspective of the defender that maximizes a defender's payoff based on the simultaneous and non-cooperative attacker-defender model, and a second estimate of a security risk associated with each of the plurality of network nodes 16 from a perspective of the attacker that maximizes an attacker's payoff based on the simultaneous and non-cooperative attacker-defender model, as described herein. Security node 17 is configured to provide (Block S146) a recommendation for at least one critical network node 16 of the plurality of network nodes 16 for adapting a level of security associated with the topology based on the NE profile, as described herein.

According to one or more embodiments, in a combination operation problem solved by the attacker where the attacker is configured to maximum network disruption on the network, and in the combination operation problem solved by the defender, the defender is configured to maximize network connectivity of the network.

According to one or more embodiments, a result of the NE profile corresponds to a price of security, POS, value, and a POS value greater than 1 indicates that there exists a loss in the defender's payoff caused by a plurality of NE conditions associated with the NE profile.

According to one or more embodiments, a result of the NE profile corresponds to a price of aggression, POA, value, and a POA value greater than 1 indicates that there exists a loss in the attacker's payoff caused by a plurality of NE conditions associated with the NE profile.

According to one or more embodiments, the attacker's payoff and the defender's payoff correspond to an outcome of the simultaneous and non-cooperative attacker-defender model that is based on strategies of the attacker and defender.

According to one or more embodiments, the NE is an approximation computed after a predefined time limit.

According to one or more embodiments, the adapting of the level of security associated with the topology comprises at least one of: provisioning additional security assets, and adjusting a security strategy.

According to one or more embodiments, the adapting of the level of security associated with the topology is configured to reduce the attacker's payoff.

According to one or more embodiments, the processing circuitry 98 is further configured to detect an attack on at least one of the plurality of network nodes 16, and the simulation is in response to the detected attack.

According to one or more embodiments, the network data comprises at least one of: traffic exchange among the plurality of network nodes 16, and information received from monitoring the topology.

Having described the general process flow of arrangements of the disclosure and having provided examples of hardware and software arrangements for implementing the processes and functions of the disclosure, the sections below provide details and examples of arrangements for network security through critical node game (CNG).

Some embodiments provide network security through critical node game (CNG). One or more functions described below may be performed by one or more entities in system 10. For example, one or more functions described below may be performed by security node 17 via one or more of processing circuitry 98, processor 100, simulation unit 32, etc.

### The Critical Node Game (CNG)

While the CNP models a wide range of applications from interdiction to network resilience, it only encompasses a single decision-maker. Therefore, one or more embodiments extend the CNP illustrated on Equation 1 into the CNG by introducing two different decision-makers: the defender, who controls the variables x, and the attacker, who controls the variables α. Similarly to the CNP, it may be assumed that for any i∈, xᵢ=1 if and only if the defender (e.g., node in communication system 10) protects node i, and αᵢ=1 if and only if the attacker (e.g., another node in communication system 10) attacks node i.
Definition 2 (Critical Node Game). Given a graph G, the CNG is a 2-player simultaneous and non-cooperative game with complete information where the first player (the defender) solves

$${max}_{x} {f}^{( i} ( x ; α ) : {d}^{T} x \leq D , x ∈ 0 , {1}^{\vert V \vert} , \qquad ( 2 )$$

In one or more embodiments, a simultaneous and non-cooperative game may include instantaneity of attack.

And the second player (the attacker) solves

$${max}_{α} {f}^{α} ( α ; x ) : {a}^{T} α \leq A , α ∈ 0 , {1}^{\vert V \vert} , \qquad ( 3 )$$

$$Where d ∈ {ℝ}_{+}^{\vert V \vert} , a ∈ {ℝ}_{+}^{\vert V \vert} , D ∈ {ℝ}_{+} , A ∈ {ℝ}_{+} .$$

In CNG, it may be implicitly assumed that the defender maximizes a function ƒ^{d} of x parameterized in α that represents the connectivity of the network G. Symmetrically, the attacker maximizes a function ƒ^{α} of α parameterized in x that represents the network disruption on G. In this sense, the players' objective functions are misaligned. Furthermore, the weights a and d represent the resources the player spends for selecting (i.e., defending or attacking) the nodes, while A and D represent the players' resources budgets.

As used herein, the game being simultaneous may mean that the players chose their strategy (i.e., solve their optimization problems) simultaneously without knowing the other players' strategies.

Any feasible x (α) may be defined as a strategy for the defender (attacker). Any tuple (x,α) may be called a strategy profile for the game, and ƒ^{d} (ƒ^{a}) evaluated at (x,α) the defender's (attacker's) payoff under (x,α).

The Nash Equilibrium (NE) is considered as the standard solution concept. A strategy profile (x̅,α̅) is a NE if no player can unilaterally deviate from their strategy without decreasing their payoff. This concept is formalized in Definition 3.
Definition 3 (NE) A profile (x̅,α̅) is a NE if (i.) ƒ^{d}(x̅,α̅)≥ƒ^{d}(\tilde{x},\tilde{α}) for any \tilde{x}∈{x∈{0,1}^{|V|}:d^{T}x≤D}, and (ii.) ƒ^{a}(x̅,α̅)≥ƒ^{a}(x̅,\tilde{α}) for any \tilde{α}∈{α∈{0,1}^{|V|}:a^{T}α≤A}.

The focus may be on deterministic, pure, NE, namely, it may be assumed that the players select strategies that are feasible for their constraints as opposed to selecting convex combinations of feasible strategies. Pure NEs may not exist for finite games such as the CNG, namely, for games with a finite number of players and a finite number of strategies; indeed, the problem of determining if an NE exists in integer programming games is

$${\sum }_{2}^{p} - complete ,$$

i.e., as long as

$$𝒩𝒫 \neq {\sum }_{2}^{p}$$

the decision problem cannot be represented as an integer program of polynomial size. Whenever a NE does not exist, the relaxed concept of approximate (often called ϵ) NE, as formalized in definition 4 may be relied upon.
Definition 4 Approximate NE Given Φ∈R₊, a strategy profile (x̅,α̅) is a (pure) approximate Φ−NE for if (i.) ƒ^{d}(x̅,α̅)+Φ≥ƒ^{d}(\tilde{x},α̅) for any \tilde{x}∈{x∈{0,1}^{|V|}:d^{T}x≤D}, and (ii.) ƒ^{a}(x̅,α̅)+Φ≥ƒ^{a}(x̅,\tilde{α}) for any \tilde{α}∈{α∈{0,1}^{|V|}:a^{T}α≤A}.

In a Φ−NE, the constant Φ∈R₊ represents an upper bound on the deviations that the players' payoff can have. Whenever Φ=0, the Φ−NE is also an exact NE.

### Prices

Whenever multiple equilibria exist, their properties (e.g., the players' payoffs under the equilibria) may differ. This may be why one aim is to select the equilibria exhibiting some desired properties. Specifically, the aim may be to select the NE that maximizes the defender's payoff and the NE that maximizes the attacker's payoff. If different, these two NEs may practically provide the best “stable” outcome—in terms of aggressive or defensive strategy—for the attacker or the defender, respectively. This information can guide the design of extra layers of security mechanisms, and it can help provide real-time prescriptive strategies to defend the critical infrastructure. In this section, these intuitions are formalized with the concepts of POS and POA.
Definition 5 (Joint Outcomes Space) The joint outcomes space for the CNG is the set

$$𝒥 = \{ ( x , α ) : {d}^{T} x \leq D , {a}^{T} α \leq A , α ∈ {\{ 0 , 1 \}}^{\vert V \vert} , x ∈ {\{ 0 , 1 \}}^{\vert V \vert} \} . \qquad ( 4 )$$

The set [symbol] contains all the outcomes of the CNG, namely, all the feasible strategy profiles that players can play. If a real-valued function g(x,α):{0,1}^{|V|2}→R over [symbol] is optimized, the strategy profile (x̅,α̅) that maximizes g is obtained. There is no guarantee that the profile (x̅,α̅) is a NE.

Nevertheless, comparing (x̅,α̅) with the NEs maximizing g enables the evaluation of the loss in performance due to the equilibrium conditions. In other words, it enables the evaluation how much the stability conditions of equilibria degrade the value of g. Also, g may be the sum of the player's payoff where the Price of Stability may be the ratio between the social welfare of the best possible outcome and the social welfare of the best-possible NE. A similar metric for the CNG called the Price of Security (POS) in provided in Definition 6.

For a given Φ, let [symbol] (Φ)⊆ [symbol] be the set of Φ−NE for the CNG.
Definition 6 (Price of Security (POS)) Given a CNG instance and Φ∈R₊, let

$$( \hat{x} , \hat{α} ) = arg {max}_{x , α} \{ {f}^{d} ( x , α ) : ( x , α ) ∈ 𝒩 ( Φ ) \} ,$$

i.e., the NE maximizing ƒ^{d}(x,α); let

$$( \overline{x} , \overline{α} ) = arg {max}_{x , α} \{ {f}^{d} ( x , α ) : ( x , α ) ∈ 𝒥 \} ,$$

i.e., the strategy profile maximizing ƒ^{d}(x,α). Whenever | [symbol] (Φ)|>0, the POS is the ratio ƒ^{d}(x̅,α̅)/ƒ^{d}(\hat{x},\hat{α}).

The POS is lower bounded by 1 and, from a theoretical perspective, has no upper bound. A POS of 1 suggests that the defender, in the best-possible NE that maximizes their payoff, is not diminishing their payoff by defending their resources; hence, it suggests that the defensive strategy is highly efficient. A POS strictly greater than 1 suggests that there exists a loss in the defender's payoff caused by the NE conditions. In this sense, a larger POS indicates that the defender is paying a higher cost for defending their resources.

Symmetrically to the POS, the Price of Aggression (POA) is provided in Definition 7.

Definition 7 (Price of Aggression (POA)) Given a CNG instance and Φ∈R₊, let

$$( \hat{x} , \hat{α} ) = arg {max}_{x , α} \{ {f}^{d} ( x , α ) : ( x , α ) ∈ 𝒩 ( Φ ) \} ,$$

i.e., the NE maximizing ƒ^{a}(x,α); let

$$( \overline{x} , \overline{α} ) = arg {max}_{x , α} \{ {f}^{d} ( x , α ) : ( x , α ) ∈ 𝒥 \} ,$$

i.e., the strategy profile maximizing ƒ^{d}(x,α). Whenever | [symbol] (Φ)|>0, the POA is the ratio ƒ^{a}(x̅,α̅)/ƒ^{a}(\hat{x},\hat{α}).

From the attacker's perspective, the POA mimics the definition of the POS. It measures the relative loss in the attacker's payoff caused by the NE conditions in the NE that maximizes ƒ^{a}.

### Cloud Context

A malicious attacker can gain access to the network G via undisclosed vulnerabilities and aims to perform an attack to maximize the network disruption on G (e.g., maximizing ƒ^{a}). The defender can detect an intrusion, yet, being uncertain about the attacker's targets and the type of vulnerability the attacker could exploit. That is, while knowledge of the vulnerability can be used, one or more embodiments do not rely on knowledge of the vulnerability such that the process described herein operates without such knowledge. Gaining knowledge of vulnerabilities in a large network can be resource intensive process such that being able to operate without such knowledge save limited computing resources and allows one or more embodiments to operate in real-time or nearly in real-time. Therefore, the defender aims to protect their critical infrastructure. The defender creates a projection of the attacker's capabilities by defining the attacker's optimization model, e.g., by choosing ƒ^{a}, A, and a based on the monitoring data that warned about a possible attack and the available information regarding the exploited vulnerabilities. The attacker and the defender have limited resources for their defensive and attacking strategies (namely, a, A, d, D). While the attacker aims to maximize a measure of network disruption, the defender aims to preserve the network operations as much as possible by maximizing ƒ^{d}. The defender may activate an extra layer of security measures (i.e., a firewall or denial-of-service attack mitigation) on a subset of critical nodes by degrading the network operations by a given factor. In one or more embodiments, critical nodes may correspond to nodes that handle sensitive data and authentication mechanisms are more critical due to their impact on data integrity and security. Similarly, a critical node may be responsible for authentication and is crucial in ensuring the application's security. If this component is compromised or fails, it can lead to unauthorized access and potential data breaches. The criticality of nodes can vary depending on the specific context and requirements of the cloud-native applications. Factors such as business objectives, customer expectations, and system and network dependencies can all contribute to determining the criticality of each node.

### CNG Payoffs

CNG payoff may refer to the outcome of a game that depends on the selected strategies of the players. In one or more embodiments, “payoff” may game theory concept. Let

$${p}_{i}^{d}$$

be the parameter representing the criticality of node i∈V for the defender. Symmetrically, let

$${p}_{i}^{a}$$

be the parameter representing the projected criticality of node i according to the attacker, e.g., according to the vulnerabilities the attacker could exploit and to the importance of i. The payoffs for the two players are formulated in terms of

$${p}_{i}^{d}$$

and

$${p}_{i}^{a}$$

according to whether node i is protected (xᵢ=1) or attacked (αᵢ=1), respectively. Let δ, η, ϵ and γ be real-valued scalar parameters in [0,1] so that δ<η<ϵ. The payoff contributions follow the following scheme:
Normal operations. If xᵢ=0 and αᵢ=0, the defender gets a full payoff of

$${p}_{i}^{d}$$

as no attack is ongoing on i. However, the attacker pays an opportunity cost γ

$${p}_{i}^{a}$$

for not having attacked i.
Successful attack. If xᵢ=0 and αᵢ=1, the attacker gets a full payoff

$${p}_{i}^{a} ,$$

as the attacker successfully attacked node i. Therefore, the defender's operations on node i are worsened from

$${p}_{i}^{d} to δ {p}_{i}^{d} .$$

Mitigated attack. If xᵢ=1 and αᵢ=1, the attack is mitigated by the defender's selection of node i. Therefore, the defender's operations are degraded from

$${p}_{i}^{d} to η {p}_{i}^{d} .$$

Symmetrically, the attacker receives a payoff of

$$( 1 - η ) {p}_{i}^{a} .$$

Mitigation without attack. If xᵢ=1 and αᵢ=0, the defender protects node i without the attacker selecting node i. Therefore, the defender's operations are degraded from

$${p}_{i}^{d} to ϵ {p}_{i}^{d} .$$

Symmetrically, the attacker receives a payoff of 0.

The contribution of each node i to the players' payoff is summarized in Table 1.

TABLE 1
Game Payoffs

| | |
|---|---|
| αᵢ = 0 | αᵢ = 1 |

| | | | | |
|---|---|---|---|---|
| xᵢ = 0 | ${p}_{i}^{d}$ | $- γ {p}_{i}^{a}$ | $δ {p}_{i}^{d}$ | ${p}_{i}^{a}$ |
| xᵢ = 1 | $ϵ {p}_{i}^{d}$ | 0 | $η {p}_{i}^{d}$ | $( 1 - η ) {p}_{i}^{a}$ |

All considered, the defender's payoff is

$${f}^{d} ( x , α ) = {\sum }_{i ∈ V} ( {p}_{i}^{d} ( ( 1 - {x}_{i} ) ( 1 - {α}_{i} ) + η {x}_{i} {α}_{i} + ϵ {x}_{i} ( 1 - {α}_{i} ) + δ ( 1 - {x}_{i} ) {α}_{i} ) ) \qquad ( 5 )$$

While the attacker's payoff is

$${f}^{a} ( α , x ) = {\sum }_{i ∈ V} ( {p}_{i}^{a} ( - γ ( 1 - {x}_{i} ) ( 1 - {α}_{i} ) + ( 1 - {x}_{i} ) {α}_{i} + ( 1 - η ) {x}_{i} {α}_{i} ) ) \qquad ( 6 )$$

### Equilibria Computation Algorithm

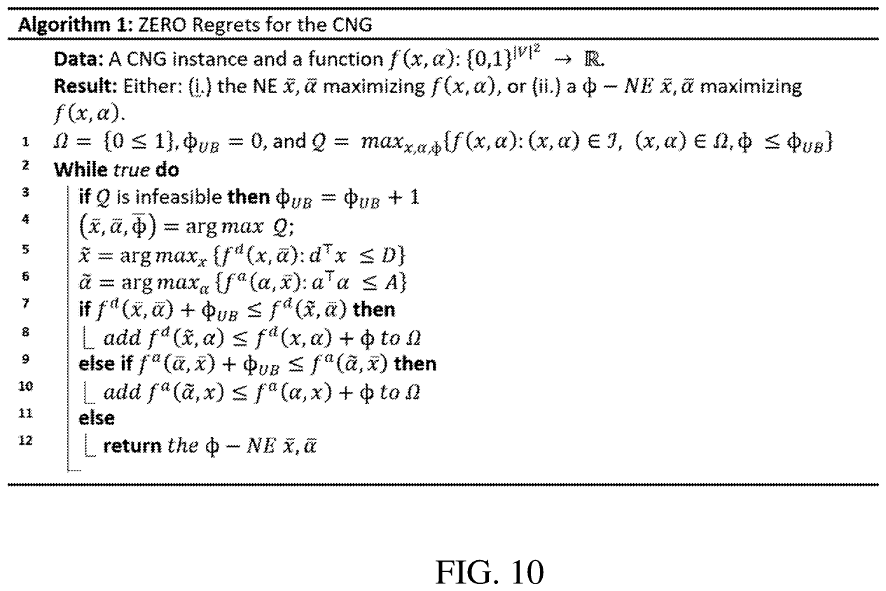

To compute equilibria for CNG, cutting-plane algorithm ZERO Regrets is used to compute NEs and Φ-NEs. The algorithm receives as an input the CNG instance (nodes setup, parameters) and a function ƒ(x,α) and returns the NE maximizing ƒ. The algorithm is depicted in FIG. 10.

The algorithm initializes (i.) an empty cutting plane pool Ω, and (ii.) Φ to 0, and (iii.) a program Q that optimizes the input function ƒ(x,α) over the joint outcome space and Ω. It may be assumed that Q is feasible and bounded at the first iteration.

Let x̅, α̅ be the maximizers of Q. The task is to determine whether x̅, α̅ is a NE or not. This is equivalent to checking whether the defender (resp, the attacker) can unilaterally and profitably deviate to another strategy \tilde{x} (resp. \tilde{α}). The algorithm solves the defender's (resp. attacker's) optimization problem in FIG. 10 (Line 5) (resp. FIG. 10 (Line 6) for the attacker), by letting x (resp. α) be a variable while fixing α to α̅ (resp. x to x̅). If the defender payoff ƒ^{d}(resp. attacker payoff ƒ^{a}) under the profile \tilde{x}, α̅ (resp. x̅, \tilde{α} is better than the one under x̅,α̅, then \tilde{x} (resp. ã) is a deviation; by definition, x̅, α̅ cannot be a NE. Therefore, the algorithm cuts off x̅, α̅ from Q via the cutting plane in FIG. 10 (Line 8) (resp. FIG. 10 (Line 10)) with a so-called equilibrium inequality, i.e., an inequality that does not cut off any NE. If no deviation exists for the attacker and the defender, then the algorithm returns a NE in FIG. 10 (Line 12). It generalizes the previous reasoning by allowing any profitable deviation to be incremented by at most Φ̅ to enable the computation of Φ-NE. Whenever Q becomes infeasible (FIG. 10 (Line 3)), then no Φ-NE can exist with Φ≤Φ_{UB}; therefore, it heuristically increments Φ_{UB} by one unit.

### CNG in Cloud

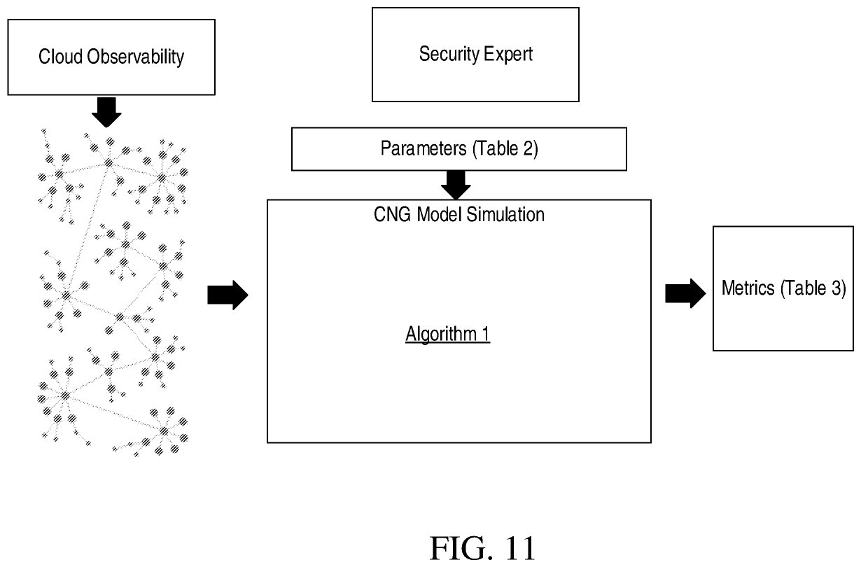

Upon the presence of complex network graphs in the cloud ecosystem (public, private or hybrid), the cloud operators can run the algorithm depicted in FIG. 10 by specifying a time limit and let the algorithm produce a feasible solution. To guarantee that the latter is produced by the algorithm, the best increment Φ-NE is stored at each iteration, that is, the solution x̅, α̅ with the smallest Φ̅. If the algorithm hits a time limit, it returns the best incumbent Φ-NE found. FIG. 11 is a diagram according to one or more embodiments and depicts how the simulation of the proposed CNG model on cloud premises. A security expert can tweak simulation parameters (Table 2) upon a reception of a certain observability data representing network graph. The simulation component runs and return a certain number of metrics (Table 3).

TABLE 2
simulation parameters

| Parameter | Description |
|---|---|
| γ | Attacker's opportunity cost factor |
| η | Defender's mitigated attack factor |
| ϵ | Defender's Mitigation without attack factor |
| δ | Attacker's successful attack factor |
| D | Defender's budget |
| A | Attacker's budget |
| T | Time limit to run Equilibria computation |

TABLE 3
Simulation Metrics

| Metric | Description |
|---|---|
| POS | Price of Security |
| POS Range | Price of Security range values during simulation |
| | (minimum, maximum) |
| POA | Price of Attack |
| POA Range | Price of Aggression range values during simulation |
| | (minimum, maximum) |
| Φ − NE | The average value for Φ − NE |
| f^{d} | The average defender's payoff |
| f^{a} | the average attacker's payoff |
| t | Simulation time to compute equilibrium; less or equal to T |

### Parameters Selection

The parameters assignment is typically empirical, for instance, the attacker's opportunity cost γ is generally considered to be either 0 or 0.1 as attacking may expose the exact dynamics of the attack (e.g., the type of vulnerabilities exploited by the attacker) while not attacking may give time to the network operator to investigate on the attack. The magnitude of the mitigated-attack factor η depends on the type of defensive resources deployed by the network operator; for instance, some firewall filtering rules may significantly slow down the overall network operations, whereas some may have milder effects on the network performance. Therefore, a security expert can select a low (i.e., 0.60) and a high (i.e., 0.80) value of η. The mitigation-without-attack factor ϵ is based on a η plus an extra benefit (i.e., ϵ=1.25 η) since no attack is ongoing. The successful-attack factor δ is based on n minus an extra cost due to the unmitigated attack (i.e., δ=0.8 η). The budgets A and D are strictly instance-dependent since they model the players' ability to select nodes in the network. A security expert can consider large-scale attacks where the defender generally has resources to protect either 30% or 75% of the network, as of contractual agreements with the customers regarding the degradation of services (i.e., the so-called Service Level Agreements (SLA)). As of these agreements, the defender may be contractually obliged to guarantee a minimal level of service to its customer. In contrast, the attacker can attack 3%, 10% or 30% of the nodes.

### Metrics Interpretation

A driven simulation produces a set of insights that provide a security posture through the following observations:
Nash Equilibrium (NE) represents a profile (x̅,α̅) under what the attacker and defender focus on a certain node to defend or attack, where neither attacker nor defender can unilaterally deviate from their strategy without decreasing their payoff.
Nash Equilibrium (NE) as a profile can be found in non-complex cloud network use case, where cardinality of vertices is not high (see illustrative example).
In more complex scenarios (e.g., 300 nodes in Synthetic instances as well as in some cases in real world cloud network), a Nash Equilibrium as a profile solution is hard to achieve. An approximate NE (Φ-NE) is computed after a certain time limit T.
The POS minimal possible value of 1 implies that the defender, in the best-possible NE that maximizes their payoff, is not diminishing their payoff by defending their resources; hence, it suggests that the defensive strategy is highly efficient.
A POS strictly greater than 1 implies that there exists a loss in the defender's payoff caused by the NE conditions. In this sense, a larger POS indicates that the defender is paying a higher cost for defending resources.
The ratio between Φ-NE and the defender payoff illustrates the approximation layer for the best profile setup for the defender. Respectively, the ratio Φ-NE and the attacker payoff illustrates a deviation the attacker may have with limited success in the attack.
Lower POS indicates that the defender can commit to equilibria strategies that are close, in terms of efficiency, to the best possible strategy (defined in the joint outcome space).
The variation of POS from small-scale to high-scale attacks depicts defense degradation performance through multiple scenarios.
An equilibrium solution x̅ is a binary vector (See Table 5), representing the best defense strategy, where a defender can strengthen security on a subset of nodes (indices of the binary vector with value 1).

### Example

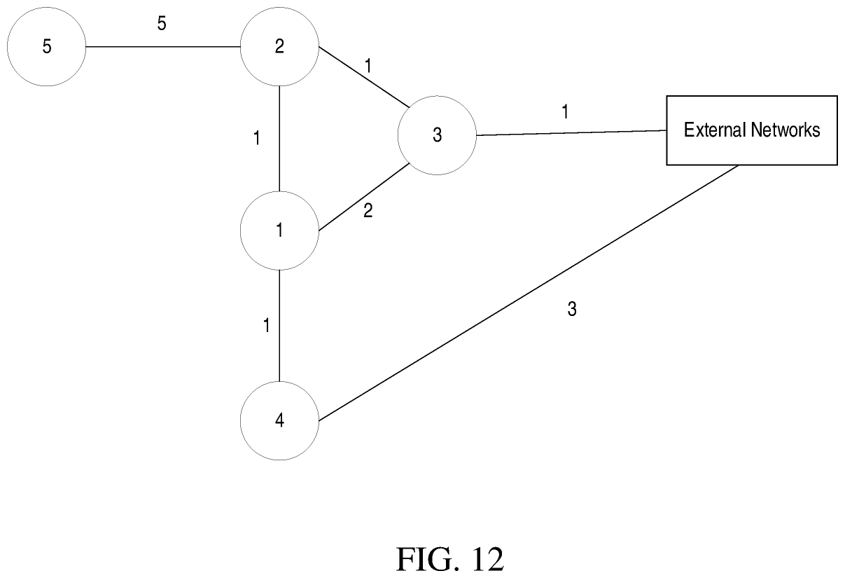

Consider a cloud network given by G=(V,E) with |V|=6, and |E|=7 as in FIG. 12. The cloud operator manages nodes 1, . . . , 5 while node 6 virtually represents the external network (e.g., the Internet). An attacker manages to penetrate the network G and observes the traffic exchanged among the nodes. Once the attack has been detected, the network operator (or network node) solves a CNG to determine the best defensive strategy. Based on the information received from the monitoring systems (observability on the cloud), the network operator formulates a CNG with the parameters of Table 4. The weights on the edges represent the amount of traffic exchanged between the nodes.

TABLE 4
Scenario and Parameters

| | | | | | | Para- | |
|---|---|---|---|---|---|---|---|
| | Node 1 | Node 2 | Node 3 | Node 4 | Node 5 | meter | Value |
| Traffic | 4 | 7 | 4 | 4 | 5 | A | 25.50 |
| ${p}_{i}^{d}$ | 9 | 2 | 30 | 3 | 8 | D | 40.00 |
| ${p}_{i}^{a}$ | 6 | 10.5 | 18 | 6 | 7.5 | δ | 0.06 |
| d | 3 | 6 | 8 | 7 | 7 | η | 0.40 |
| a | 6 | 4 | 7 | 9 | 1 | ϵ | 1.00 |

The associated CNG admits the two exact (i.e., Φ=0) NEs of Table 5. For example, in Table 5 a “0” may indicate not to protect while a “1” indicates to protect. Specifically, the defender achieves, in both cases, a payoff ƒ^{d}(x̅,α̅) of 29.2. However, the attacker has a payoff ƒ^{a} (α̅, x̅) of 13.74 and 12.18 in equilibrium 1 and 2, respectively. The POS for the instance is 1.78 for both the equilibria (e.g., the ratio between

$${\sum }_{i} {p}_{i}^{d} = 52$$

and 29.2), and it intuitively explains that the defender degrades their payoff 1.78 times to defend the network with the Nash equilibria. Symmetrically, the POA for the instance is 1.86 and 2.09 in equilibrium 1 and 2, respectively. This price indicates that the attacker's payoff decreases at most 2.09 times in equilibrium 2 compared to the most successful attack (e.g., when the defender does not protect any node). Although the two equilibria are equally advantageous for the defender, the POA provides an insight into the best equilibrium. Indeed, from a practical perspective, the network operator should select equilibrium 2, as it damages the attacker the most.

TABLE 5
NE associated with the Example

| | x̅ | α̅ | POS | POA |
|---|---|---|---|---|
| Equilibrium 1 | [1, 1, 1, 0, 1] | [0, 0, 1, 0, 1] | 1.78 | 1.86 |
| Equilibrium 2 | [1, 1, 1, 0, 1] | [0, 0, 1, 0, 1] | 1.78 | 2.09 |

### CNG Validation

Referring to Section 5 in the Appendix. In this section, two experiments have been performed: (1) synthetic instances and (2) real cloud dataset representing a snapshot of distributed cloud native application running at the top of Kubernetes (K8S).

### Cloud Implementation

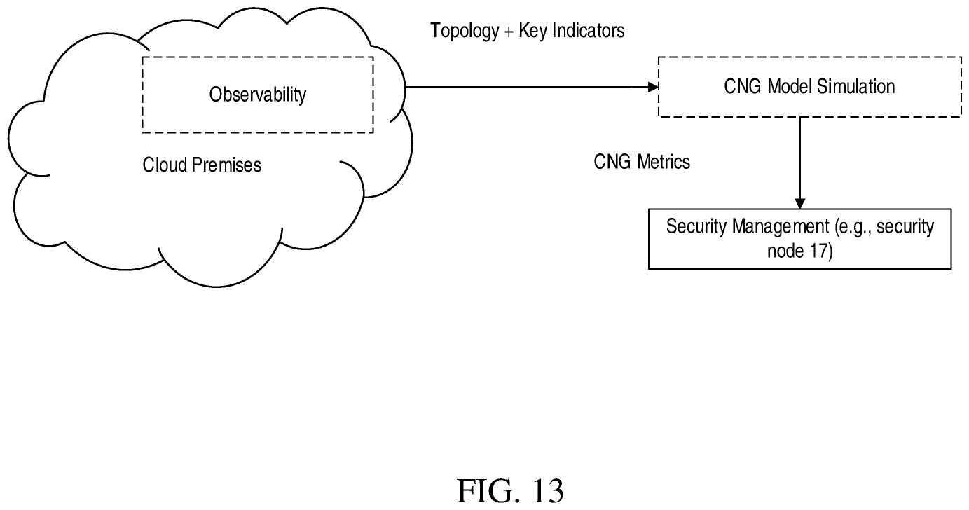

Virtualized instances could be deployed on cloud constituting a set of assets that the model described herein can assess the security risk through observability. FIG. 13 is a diagram illustrating an example approach on how the approach can be integrated on cloud premises considering a security management layer.

### O-RAN Implementation

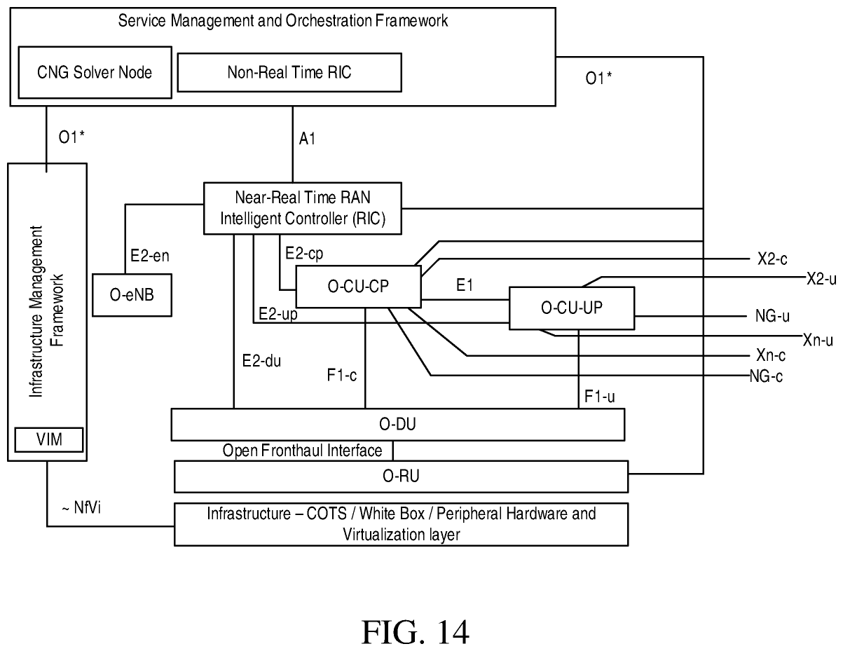

O-RAN is a synergy between hardware and virtualized function constituting a complex ecosystem, where the risk may need to be assessed. A certain observability agent can collect info on the topology and run the critical node game theoretic model to assess the security risk. Such node can be part of a management layer. The service management and orchestration framework in the O-RAN architecture depicted in FIG. 14 has the ability to observe diverse indicators on interfaces as well as knowing how functions communicate to each other. The collected intelligence can be pushed to a modeling node to run the solution and generate an assessment to management.

### 3GPP Technical Specification Impact

From an assurance perspective, 3GPP and ETSI NFV emphasize the elaboration of SCAS documentation of network products. In such situation, the focus is put over products and/or services. However, the approach described herein is different in the sense it may consider interaction of products/services, as well as being agnostic with respect diverse attacks under the assumption that there are cyber-attacks uncertainty. 3GPP or ETSI NFV may have another way to map assurance to a set of assets as whole as well as considering cyber-attack uncertainty rather than considering a map of cyber-threat modeling.

The cloud security embodiments described herein may be based on a simultaneous and non-cooperative attacker-defender game/model where each player solves a combinatorial optimization problem parametrized in the variables of the other player.

This approach advantageously enables security experts to one or more of:
1. Assess the cyber security metrics of the cloud network given a certain level of observability;
2. Picture the security posture through two security metrics, namely, the price of security and the price of aggression. These metrics can guide the design of security mechanisms and provide real-time prescriptive strategies to defend cloud critical infrastructure; and
3. Adapt the level of cyber-protection deployed on the network by considering cyber-attacks uncertainty.

Some other advantages of one or more embodiments are as follows:
1. Game based security metrics in complex IT premises meanwhile considering cyber-attacks uncertainty;
2. Security metrics on whole operating network functions instead of considering individual network functions;
3. Adaptive to complex interaction network graph, which is the common trend deployment in distributed cloud premises; and
4. Modeling is performed with respect to two perspectives (actors), namely, attacker and defender.

### EXAMPLES

Example A1. A security node 17 comprising:
processing circuitry 98 configured to:
   simulate a simultaneous and non-cooperative attacker-defender model where:
      an attacker solves a combinational operation problem based on variables associated with a defender; and
      the defender solves a combination operational problem based on variables associated with the attacker;
   determine a Nash Equilibrium, NE, profile that maximizes the defender's payoff based on the simultaneous and non-cooperative attacker-defender model;
   determine the NE profile that maximizes the attacker's payoff based on the simultaneous and non-cooperative attacker-defender model; and
   adjust at least one security strategy for a network based on the NE profile.
Example A2. The security node 17 of Example A1, wherein, in the combination operation problem solved by the attacker, the attacker is configured to maximum network disruption on the network; and
in the combination operation problem solved by the defender, the defender is configured to maximize network connectivity of the network.
Example A3. The security node 17 of Example A1, wherein a result of the NE profile corresponds to a price of security, POS, value; and
a POS value greater than 1 indicating that there exists a loss in the defender's payoff caused by NE conditions.
Example A4. The security node 17 of Example A1, wherein a result of the NE profile corresponds to a price of aggression, POA, value; and
a POA value greater than 1 indicating that there exists a loss in the attacker's payoff caused by NE conditions.
Example A5. The security node 17 of any one of Examples A1-A4, wherein the attacker's payoff and the defender's payoff corresponds to an outcome of the simultaneous and non-cooperative attacker-defender model that is based on strategies of the attacker and defender.
Example A6. The security node 17 of any one of Examples A1-A5, wherein the NE is an approximation computed after a predefined time limit.
Example B1. A method implemented in a security node 17, the method comprising:
simulating a simultaneous and non-cooperative attacker-defender model where:
   an attacker solves a combinational operation problem based on variables associated with a defender; and
   the defender solves a combination operational problem based on variables associated with the attacker;
determining a Nash Equilibrium, NE, profile that maximizes the defender's payoff based on the simultaneous and non-cooperative attacker-defender model;
determining the NE profile that maximizes the attacker's payoff based on the simultaneous and non-cooperative attacker-defender model; and
adjusting at least one security strategy for a network based on the NE profile.
Example B2. The method of Example B1, wherein, in the combination operation problem solved by the attacker, the attacker is configured to maximum network disruption on the network; and
in the combination operation problem solved by the defender, the defender is configured to maximize network connectivity of the network.
Example B3. The method of Example B1, wherein a result of the NE profile corresponds to a price of security, POS, value; and
a POS value greater than 1 indicating that there exists a loss in the defender's payoff caused by NE conditions.
Example B4. The method of Example B1, wherein a result of the NE profile corresponds to a price of aggression, POA, value; and
a POA value greater than 1 indicating that there exists a loss in the attacker's payoff caused by NE conditions.
Example B5. The method of any one of Examples B1-B4, wherein the attacker's payoff and the defender's payoff corresponds to an outcome of the simultaneous and non-cooperative attacker-defender model that is based on strategies of the attacker and defender.
Example B6. The method of any one of Examples B1-B5, wherein the NE is an approximation computed after a predefined time limit.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviations | Explanation |
|---|---|
| CNP | Critical Node Problem |
| NE | Nash Equilibrium |
| CNG | Critical Node Game |
| POS | Price of Security |
| POA | Price of Aggression or Attack |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a security node, the method comprising:
using a topology of a plurality of network nodes and associated network data in a network to simulate a simultaneous and non-cooperative attacker-defender model to assess a security risk associated with each of the plurality of network nodes, where:
an attacker solves a combinational operation problem based on variables associated with a defender; and
the defender solves a combination operational problem based on variables associated with the attacker;
determining a Nash Equilibrium, NE, profile that includes:
a first estimate of a security risk associated with each of the plurality of network nodes from a perspective of the defender that maximizes a defender's payoff based on the simultaneous and non-cooperative attacker-defender model; and
a second estimate of a security risk associated with each of the plurality of network nodes from a perspective of the attacker that maximizes an attacker's payoff based on the simultaneous and non-cooperative attacker-defender model; and
providing a recommendation for at least one critical network node of the plurality of network nodes for adapting a level of security associated with the topology based on the NE profile.

2. The method of claim 1, wherein, in a combination operation problem solved by the attacker, the attacker is configured to maximum network disruption on the network; and
in the combination operation problem solved by the defender, the defender is configured to maximize network connectivity of the network.

3. The method of claim 1, wherein a result of the NE profile corresponds to a price of security, POS, value; and
a POS value greater than 1 indicating that there exists a loss in the defender's payoff caused by a plurality of NE conditions associated with the NE profile.

4. The method of claim 1, wherein a result of the NE profile corresponds to a price of aggression, POA, value; and
a POA value greater than 1 indicating that there exists a loss in the attacker's payoff caused by a plurality of NE conditions associated with the NE profile.

5. The method of claim 1, wherein the attacker's payoff and the defender's payoff corresponds to an outcome of the simultaneous and non-cooperative attacker-defender model that is based on strategies of the attacker and defender.

6. The method of claim 1, wherein the NE is an approximation computed after a predefined time limit.

7. The method of claim 1, wherein the adapting of the level of security associated with the topology comprises at least one of:
provisioning additional security assets; and
adjusting a security strategy.

8. The method of claim 1, wherein the adapting of the level of security associated with the topology is configured to reduce the attacker's payoff.

9. The method of claim 1, further comprising detecting an attack on at least one of the plurality of network nodes; and
the simulation being in response to the detected attack.

10. The method of claim 1, wherein the network data comprises at least one of:
traffic exchange among the plurality of network nodes; and
information received from monitoring the topology.

11. A security node, comprising:
processing circuitry configured to:
use a topology of a plurality of network nodes and associated network data in a network to simulate a simultaneous and non-cooperative attacker-defender model to assess a security risk associated with each of the plurality of network nodes, where:
an attacker solves a combinational operation problem based on variables associated with a defender; and
the defender solves a combination operational problem based on variables associated with the attacker;
determine a Nash Equilibrium, NE, profile that includes:
a first estimate of a security risk associated with each of the plurality of network nodes from a perspective of the defender that maximizes a defender's payoff based on the simultaneous and non-cooperative attacker-defender model; and
a second estimate of a security risk associated with each of the plurality of network nodes from a perspective of the attacker that maximizes an attacker's payoff based on the simultaneous and non-cooperative attacker-defender model; and
provide a recommendation for at least one critical network node of the plurality of network nodes for adapting a level of security associated with the topology based on the NE profile.

12. The security node of claim 11, wherein, in a combination operation problem solved by the attacker, the attacker is configured to maximum network disruption on the network; and
in the combination operation problem solved by the defender, the defender is configured to maximize network connectivity of the network.

13. The security node of claim 11, wherein a result of the NE profile corresponds to a price of security, POS, value; and
a POS value greater than 1 indicating that there exists a loss in the defender's payoff caused by a plurality of NE conditions associated with the NE profile.

14. The security node of claim 11, wherein a result of the NE profile corresponds to a price of aggression, POA, value; and
a POA value greater than 1 indicating that there exists a loss in the attacker's payoff caused by a plurality of NE conditions associated with the NE profile.

15. The security node of claim 11, wherein the attacker's payoff and the defender's payoff corresponds to an outcome of the simultaneous and non-cooperative attacker-defender model that is based on strategies of the attacker and defender.

16. The security node of claim 11, wherein the NE is an approximation computed after a predefined time limit.

17. The security node of claim 11, wherein the adapting of the level of security associated with the topology comprises at least one of:
provisioning additional security assets; and
adjusting a security strategy.

18. The security node of claim 11, wherein the adapting of the level of security associated with the topology is configured to reduce the attacker's payoff.

19. The security node of claim 11, wherein the processing circuitry is further configured to detect an attack on at least one of the plurality of network nodes; and
the simulation being in response to the detected attack.

20. The security node of claim 11, wherein the network data comprises at least one of:
traffic exchange among the plurality of network nodes; and
information received from monitoring the topology.
